(19) United States
(12) Patent Application Publication
(10) Pub. No.: US 2022/0222627 A1
(43) Pub. Date: Jul. 14, 2022

(54) Systems and Methods that Facilitate Hiring and Recruitment

(71) Applicant: Asurion, LLC, Nashville, TN (US)

(72) Inventors: Jason Carnicelli, Nashville, TN (US); Damien Thioulouse, Nashville, TN (US); Ryan Nicoletto, Nashville, TN (US); Christopher Wergin, Nashville, TN (US)

(73) Assignee: Asurion, LLC, Nashville, TN (US)

(21) Appl. No.: 17/585,310

(22) Filed: Jan. 26, 2022

Related U.S. Application Data
(63) Continuation of application No. 16/805,556, filed on Feb. 28, 2020, now abandoned.

(51) Int. Cl. G06Q 10/10; G06F 17/16; G06Q 10/06

(52) U.S. Cl. CPC G06Q 10/1053; G06Q 10/06398; G06Q 10/063112; G06F 17/16

(57) ABSTRACT

A disclosed system includes a processor circuit that is configured to evaluate a candidate for employment. The processor circuit performs operations including receiving a first dataset representing preferences for characteristics of an employee, receiving a second dataset representing characteristics of the candidate for employment, and generating a difference metric that represents deviations between the first dataset and the second dataset. The processor circuit may be further configured to compare the difference metric to a predetermined suitability threshold, and to designate the candidate as a suitable candidate when the difference metric is less than the threshold. The system may further include a display device and a user input device. The processor circuit may control the display device to display questions to a user on a graphical user interface, and to control the user input device to receive user data from the user in response to the presented questions.

### CROSS-REFERENCE TO RELATED APPLICATIONS

The present application claims benefit of U.S. Provisional Application No. 62/812,660, filed Mar. 1, 2019, the entire contents of which is incorporated herein by reference.

### BRIEF DESCRIPTION OF THE DRAWINGS

The accompanying drawings form part of the disclosure and are incorporated into the subject specification. The drawings illustrate example embodiments of the disclosure and, in conjunction with the present description and claims, serve to explain various principles, features, and elements of the disclosure. Certain embodiments of the disclosure are described more fully below with reference to the accompanying drawings. However, various aspects of the disclosure may be implemented in many different forms and should not be construed as limited to the implementations set forth herein. Like numbers refer to like, but not necessarily the same or identical, elements throughout.

FIG. 1 is a flow chart illustrating operations performed by a system, according to an embodiment of the present disclosure.

FIG. 2 illustrates a process of generating a score for a candidate based on one or more metrics, according to an embodiment of the present disclosure.

FIG. 3 illustrates a process of generating a match score for a candidate based on one or more metrics, according to an embodiment of the present disclosure.

FIG. 4 illustrates welcome screen of a system interface, according to an embodiment of the present disclosure.

FIG. 5 illustrates a contact information screen of a system interface, according to an embodiment of the present disclosure.

FIG. 6 illustrates an account creation screen of a system interface, according to an embodiment of the present disclosure.

FIG. 7 illustrates a business description screen of a system interface, according to an embodiment of the present disclosure.

FIG. 8 illustrates a position description screen of a system interface, according to an embodiment of the present disclosure.

FIG. 9 illustrates a business assessment introductory screen of a system interface, according to an embodiment of the present disclosure.

FIG. 10 illustrates a business assessment questionnaire screen of a system interface, according to an embodiment of the present disclosure.

FIG. 11 illustrates a pricing screen of a system interface, according to an embodiment of the present disclosure.

FIG. 12 illustrates a payment screen of a system interface, according to an embodiment of the present disclosure.

FIG. 13 illustrates a job posting information screen of a system interface, according to an embodiment of the present disclosure.

FIG. 14 illustrates a job description screen of a system interface, according to an embodiment of the present disclosure.

FIG. 15 illustrates a business preferences screen of a system interface, according to an embodiment of the present disclosure.

FIG. 16 illustrates a confirmation screen of a system interface, according to an embodiment of the present disclosure.

FIG. 17 illustrates a candidate application screen of a system interface, according to an embodiment of the present disclosure.

FIG. 18 illustrates an experience information screen of a system interface, according to an embodiment of the present disclosure.

FIG. 19 illustrates an assessment introductory screen of a system interface, according to an embodiment of the present disclosure.

FIG. 20 illustrates a candidate assessment questionnaire screen of a system interface, according to an embodiment of the present disclosure.

FIG. 21 illustrates a candidate confirmation screen of a system interface, according to an embodiment of the present disclosure.

FIG. 22 illustrates a business login screen of a system interface, according to an embodiment of the present disclosure.

FIG. 23 illustrates a business dashboard of a system interface, according to an embodiment of the present disclosure.

FIG. 24 illustrates a candidate match list screen of a system interface, according to an embodiment of the present disclosure.

FIG. 25 illustrates a candidate summary screen of a system interface, according to an embodiment of the present disclosure.

FIG. 26 is a flow chart illustrating a method of evaluating a candidate for employment, according to an embodiment of the present disclosure.

FIG. 27 is a block diagram of an example computer system, in which disclosed embodiments may be implemented, according to an embodiment of the present disclosure.

### DETAILED DESCRIPTION

Disclosed systems and methods provide a practical solution to ongoing hiring and recruiting challenges faced by many businesses. In this regard, disclosed embodiments provide a fast way for businesses to assess a candidate applicant's suitability for the business culture and management style of the business, as well as predicting the candidate applicant's suitability for the job from a perspective of skills, experience, and personality traits. As such, disclosed embodiments may provide cost and time savings associated with the process of determining if a candidate is a good fit for an open position.

Disclosed embodiments include a hiring and recruitment enhancement platform that may be implemented as a software application running locally on a mobile device, desktop, or laptop computer, or may be configured as an on-line application providing a web-based user interface. An embodiment system may be configured to provide a framework for performing one or more tasks that are useful for employers seeking candidates for employment and for job seekers. For example, a system may be configured to provide useful functionality to allow: employer onboarding, position creation, position advertisement, evaluation, and presentation, as well as post-match evaluation.

According to an embodiment, during an employer onboarding process, the employer may create a profile on the system platform. In addition to providing basic information to create a base account, the employer may also answer an assessment questionnaire. Answers to the questionnaire may provide insight regarding the employer's management style, employee preferences, business culture, and other parameters. Additionally, the employer may provide information on the type of job sought to be filled. In further embodiments, the system platform may be configured to provide custom job descriptions for any provided job position. Position details regarding compensation, employment type, and required and/or preferred skills may also be provided. This information may then be aggregated to create an employer profile or assessment for use in identifying preferred job candidates.

The system may be configured to generate, based on information received from the employer, a tailored job posting and to provide the job posting to the employer for review and revision. Upon approval, the job posting may be uploaded to leading online jobs boards (as well as to a separate job posting platform hosted by the system platform). Job seekers that access the job posting may then be directed back to the system platform (e.g., via a hypertext link). The system may be configured to then instruct the applicant regarding steps to be taken to apply for the position. In addition to providing certain contact information and work experience, the system may be configured to instruct the applicant to provide answers to an applicant assessment questionnaire. Like the employer assessment, responses to the candidate assessment may provide insight regarding the job seeker's preferences in management and work style, personality traits, and preferred work culture.

The system may be configured to evaluate the candidate applicant's submission and to create a “match score,” that quantifies similarities and differences between the job seeker's responses and those of the employer regarding various preferences. The system may be configured to only provide candidate information to the employer for applicants that have a sufficient match score to merit further review. The candidate profile, as provided to the employer, may include not only the applicant contact information and/or resume, but may also provide an applicant profile created based on the applicant assessment. As potential matched candidates are provided to the employer for review, the system may be configured to track feedback provided by the employer regarding the provided candidates. As the hiring process moves forward, certain indicators from the employer's responses to certain candidates (for example, declining an applicant that has insufficient experience) may be used to further adjust the employer's assessment to optimize matching with future applicants.

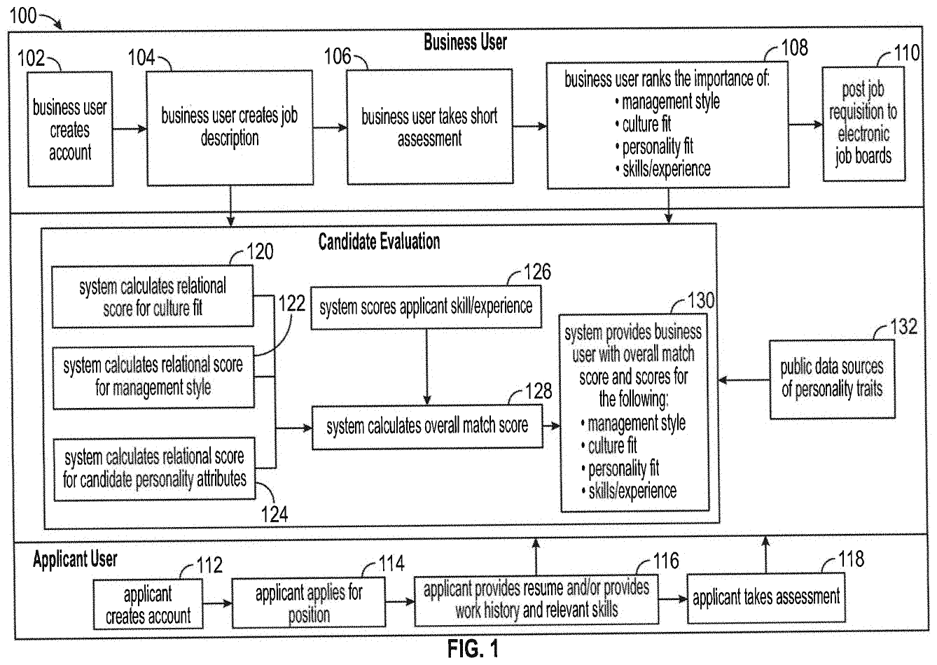

FIG. 1 is a flow chart 100 illustrating operations performed by a system, according to an embodiment of the present disclosure. In a first stage 102, a business user or employer may interact with the system to create an account. In this regard, a business user may provide a first and last name, a business name, a phone number, a physical address, an email address, etc. The business user may then create a password. Creation of an account may further require the user to provide responses to one or more security questions. The business user may further identify the industry in which they operate and may provide a brief description of their business.

In a second stage 104, the business user may interact with the system to create a job description for a position they are trying to fill. The information provided for the job description may then be used to generate a job posting. Information may include a name of the position that is to be filled and may include details regarding shift type, compensation, type of employment (full-time, part-time, etc.) desired skills, work experience, etc.

In stage 106, the employer may provide responses to various questions that may be used to determine a business user's preferences regarding management style and business culture. In stage 108, a business user may rank their preferences for a candidate regarding management style, culture fit, personality fit, and skills/experience. In stage 110, the system may create a job requisition that may be sent to various job posting boards. For example, the system may send the job posting to an electronic job posting board that is hosted by a remote server that may be accessible over the internet. The system may also post the job listing on a system or server hosted by the business.

A job seeker may access the system by responding to a job posting. For example, a job seeker may view a posted job on a job posting board that is accessible over the internet. The job posting may contain a hypertext link that may be activated to allow the job seeker to be directed to an interface to the disclosed system. In other embodiments, the job seeker could also create an account where the job seeker indicates types of jobs they prefer, uploads a resume, and takes the assessment. If the job seeker performs these actions they will get recommendations on open positions where they may be a strong candidate. This action is also a time savings for the job seeker. The system may be configured to allow the job seeker to interface with the system, as described in greater detail below.

In stage 112, the system may provide an interface to the job seeker that allows the job seeker to apply for the posted job. In this stage, the user may create an account and may provide various pieces of information to the system. For example, the job seeker may provide contact information such as name, phone number, email address, physical address, etc. The job seeker may then select a user name and password. Creation of an account may further require the job seeker to provide responses to one or more security questions.

In stage 114, the user may begin a process of applying for a posted position. In this regard, the system may be configured to guide the job seeker through various stages of the application process. For example, in stage 116 the system may provide an interface to the job seeker that allows the job seeker to upload a resume' to the system. Alternatively, a candidate also has the ability to upload a resume as part of his/her candidate profile (i.e., prior to any position being posted). The system may then request further information from the job seeker. For example, in stage 118 the system may present an interactive assessment questionnaire to the job seeker. The system may allow the job seeker to provide answers to various questions. The job seeker's responses may then provide insight regarding the job seeker's personality, and preferences regarding management style, business culture, etc.

The system may be configured to evaluate candidates that have applied for one or more posted positions and to provide recommendations to an employer regarding various candidates. For example, the system may generate a ranking of candidates or may use other metrics to evaluate candidates. For example, the system may generate one or more metrics or scores for the candidate based on respective criteria.

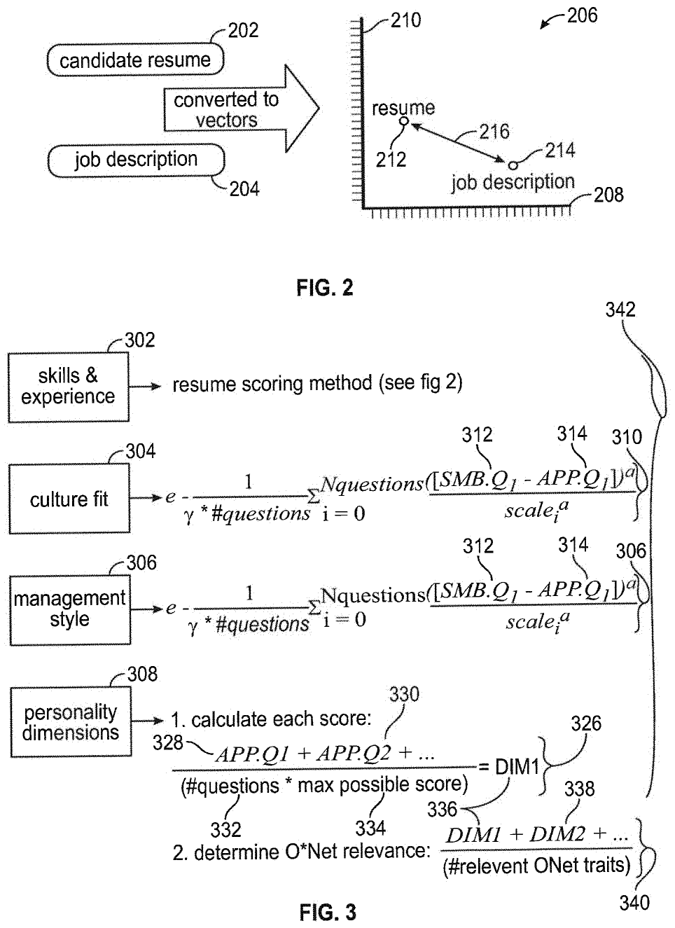

In stage 120, for example, the system may generate a relational score that characterizes a candidate applicant's cultural fit based on the candidate applicant's responses to questions regarding business culture. In stage 122, the system may generate a relational score that characterizes a candidate applicant's management style fit based on the candidate applicant's responses to questions regarding management style. In stage 124, the system may generate a relational score that characterizes a candidate applicant's personality attributes based on the candidate applicant's responses to questions geared to revealing personality traits. As described in greater detail below with reference to FIG. 2, the above-described scores may be determined relative to information provided by the employer such that a low relative score (i.e., smaller differences from business preferences) indicates a better fit between the candidate applicant's preferences and those of the employer. Regarding the overall match score, a higher overall Match Score is better indicator for the candidate to show possible fit for the applicable position.

In stage 126, the system may generate a relational score for the candidate based on their skills and experience relative to expectations for such skills and experience set by the employer. In stage 128 the system may generate an overall match score for the candidate based on one or more of the scores generated during stages 120, 122, 124, and 126. For example, in stage 128, the system may generate a match score that is a weighted average of the scores generated during stages 120, 122, 134, and 126. In further embodiments, the match score may be generated in various other ways based on various combinations of one or more of the scores generated during stages 120, 122, 134, and 126. In further embodiments, the match score may be generated using additional scores or metrics that may be relevant to the employer based on the employer's industry, business, the type of posted job, etc. Upon generating the match score based on the scores determined during stages 120, 122, 134, and 126, or based on other metrics, the system may make one or more recommendations to the employer regarding the candidate.

In stage 130, for example, the system may provide to the business user, one or more scores that characterize the job seeker's suitability for the posted job. For example, the system may provide to the business user the candidate applicant's overall match score and may provide a breakout of the candidate applicant's suitability relative to various metrics such as management style, fit to the business culture, personality fit, relevant skills and experience, etc. In generating an evaluation of a candidate applicant's suitability for a posted position, the system may gather and rely on various pieces of information 132 that may be available through various public and private sources. For example, information 132 may include publicly available data regarding personality traits that such traits relate the particular job in question. In an example embodiment, information 132 may include data obtained from a publicly accessible network such as O*NET, which is an online government database containing skills, abilities, work-styles, and other attributes relevant for thousands of jobs.

In an example embodiment, a questionnaire provided to an applicant may include questions regarding cultural fit, management style fit, personality fit, and questions relating to the candidate applicant's skills and experience, as described above. For example, a questionnaire may include 9 questions on cultural fit, 6 questions on management style fit, and 95 questions regarding a candidate applicant's personality and how it relates to the characteristics of the posted job. For example, the 95 questions may be based on the “five factor model,” which is proven personality assessment that has been used and with success for over 50 years. The five factor model maps personality traits across 5 dimensions. In other embodiments, other personality classification models may be used.

In still further embodiments, other suitable models may be used to characterize a job seeker's personality. In other embodiments, similar questionnaires may be generated having any number of questions in the various categories identified above. Further embodiments may have questionnaires having greater or fewer categories of questions as needed by the business user. Further, the questionnaire may be tailored to the particular business or industry. For example, various categories of personality traits may be emphasized or de-emphasized (i.e., may be give greater or lesser weight) based on personality traits that are deemed to be important or less important for a particular business or industry. For example, information 132 obtained from O*NET may be used to determine which personality traits are important for a given business.

According to an embodiment, an overall match score may be generated for a candidate once information from the business user and the job applicant has been submitted to the system. The overall match score may then be compared with a predetermined threshold score to determine whether the candidate merits further consideration. The business user may then be notified when one or more matches have been established. In an embodiment, the system may be configured to report only those candidates whose overall match score is less than the predetermined threshold (i.e., has a small difference relative to expectations). A business user may be notified in various ways, for example, through e-mail, text message, phone call, etc. A notification may provide information regarding one or more suitable candidates identified by the system. In other embodiments, a notification message, email, call, etc., may simply instruct the business owner to access the system in order to learn more about the suitable one or more candidates that were identified by the system.

For example, after being notified of one or more suitable candidates, the system may allow the business user to access the system through a user interface. For example, the user interface may be provided to the business user on a cell phone, tablet computer, desktop computer, etc., in the form of a graphical user interface (GUI). The business user may access the system in a similar way to that in which the business user accessed the system to initiate generation of the job posting. For example, the business user may log into an account on the system using a login and password. In further embodiments, additional security measures (e.g., two-factor authentication) may be used to access the system. Upon logging into the system, the business user may be presented with a graphical display, or dashboard, that may include information regarding matched candidates. The GUI, dashboard, etc., may provide information such as an overall match score, a candidate applicant's resume' (if provided), relevant work experience, assessment results, candidate contact information, etc. Based on the information provided, the business user may choose to reach out directly to the candidate. In further embodiments, the system may be configured to coordinate a meeting, an interview, or other contact between the business user and the candidate. The business user may then choose how to move forward including whether or not to hire the candidate.

FIG. 2 illustrates a process of generating a match score between a candidate resume and a job description. Data may be quantified by constructing a vector of values representing the context of the document from the words it contains. In an embodiment, each word may be represented by an embedding given by the gensim word2vec library (https://radimrehurek.com/gensim/models/word2vec.html). The embedding of the document is derived by averaging the word vectors obtained using the mentioned library (except stop words—i.e., words not affecting the meaning of sentences). In this way, a vector is generated from a candidate applicant's resume 202 and another vector may be generated from a job description 204. Each vector may be represented as a point in a multi-dimensional space. In this example, the n-dimensional space is projected on a two-dimensional graph 206. The “skills & experience” score is inferred by getting the cosine similarity between the applicant resume and the job description embeddings.

FIG. 3 illustrates a process of generating a match score for a candidate based on one or more metrics. In this example, the overall match score may be generated from information regarding various categories such as skills and experience 302, culture fit 304, management style 306, and personality dimensions 308. Generating a score based on skills and experience 302 was described above with reference to FIG. 2. In that example, a score was generated based on the cosine similarity between the applicant resume and the job description embeddings. Generating a score for each of the other dimensions is based on candidate applicant's answers to a set of questions asked during the application on the platform. Culture Fit 304 and Management Style Fit 306 are two attributes being assessed by comparing candidate and SMB responses to matching questions. For example, a question may be posed as “please indicate your preference on a scale of one to ten.” Any suitable numerical measure may be used. A numerical score may be generated once numerical values are generated to represent responses to questions, as described in greater detail below.

For culture fit 304 and management style 306, a mathematical expression 310 may be used to generate the fit scores. Expressions 310 for culture fit and 306 for management style are inverse exponentials of quotients. These expressions assess how closely candidate applicants' responses are from business user's response and the higher the score, the more similar applicant it to business user's responses. α and γ are parameters that can be adjusted in order to obtain comparable standard deviation and similar average to other attributes such as 302 and 308. As an example, we chose α=2.5 and γ=0.21 Each term in the sum 310 or 306 characterizes a similarity or difference between a candidate applicant's response and the business user's response. For example, expression 312 (written as SMB.Qi) may represent a numerical value for the business user's response to a first question regarding cultural fit. Expression 314 (written APP.Qi) may represent a numerical value for the candidate applicant's response to a first question regarding cultural fit. As shown in expression 310 a difference of expressions 312 and 314 is computed and that absolute value of difference is raised to power of . Similar expressions for other questions relating to cultural fit and other attributes may be computed. The scaleᵢ parameter represents the range of value that the answer to a question can take and therefore represents the maximum possible value that the numerator |SMB.Qᵢ-APP.Qᵢ| can take, regardless of the data contained in the candidate applicant's or the business user's responses. Separately, different questions may be weighted differently if required.

Various other normalization factors may also be employed as needed. In further embodiments, any other mathematical expression may be used that quantifies differences between responses provided by the business user relative to responses provided by the applicant.

The computation of a metric for personality dimensions 308 is another embodiment using a different sort of mathematical expression 362. In this example, the metric may include one or more personality traits that have been identified by the business owner. The metric given by expression 326 may quantify a candidate applicant's degree to which they possess the personality trait in question. In this regard, the numerator of expression 326 includes a sum of numerical values 328, 330, etc., that quantify the candidate applicant's responses to various questions regarding the particular personality trait. For example, expression 328 (written as APP.Q1) may represent the candidate applicant's response to a first question. Similarly, expression 330 (written as APP.Q2) may represent the candidate applicant's response to the second question, etc.

An overall score 336 (indicated as DIM1) for this particular personality trait, or personality dimension may he generated by forming a sum of all the numerical quantities (e.g., 328, 330, etc.) and by dividing by a normalization factor. In this example, the normalization factor may include a quantity 332 representing a total number of questions for this particular personality trait (also known as a personality dimension). Similarly, the normalization factor may include a multiplicative factor 334 representing the highest possible score for each question, so that the given personality dimension score is lower or equal to 1. A similar procedure may be followed to generate scores for other personality traits that are identified by a business user as being relevant to the job in question. In this way, a score 336 (written as DIM1) for a first personality dimension/trait may be added to a score 338 (written DIM2) for a second personality dimension trait, etc., to generate an overall personality score given by the expression 340.

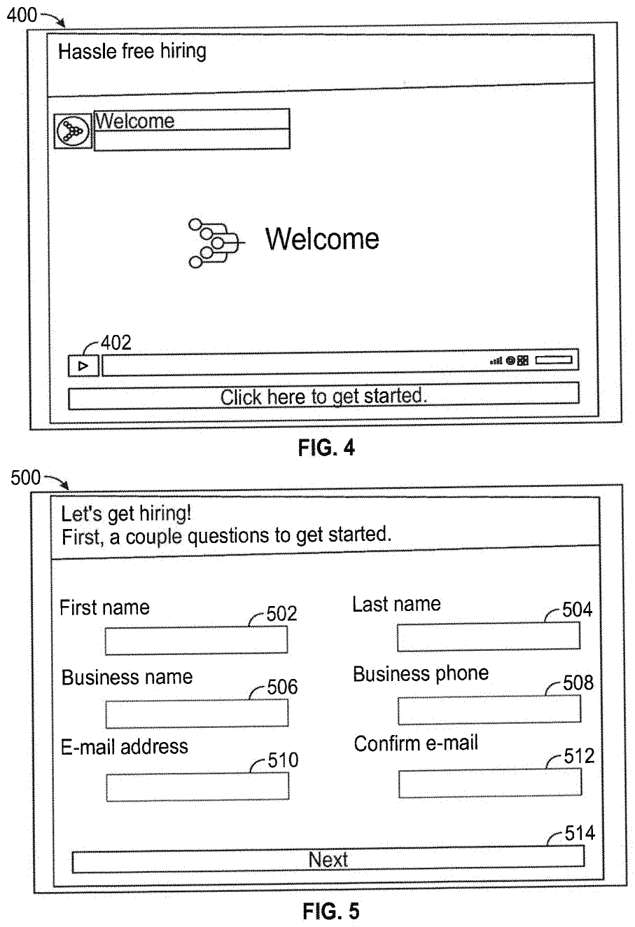

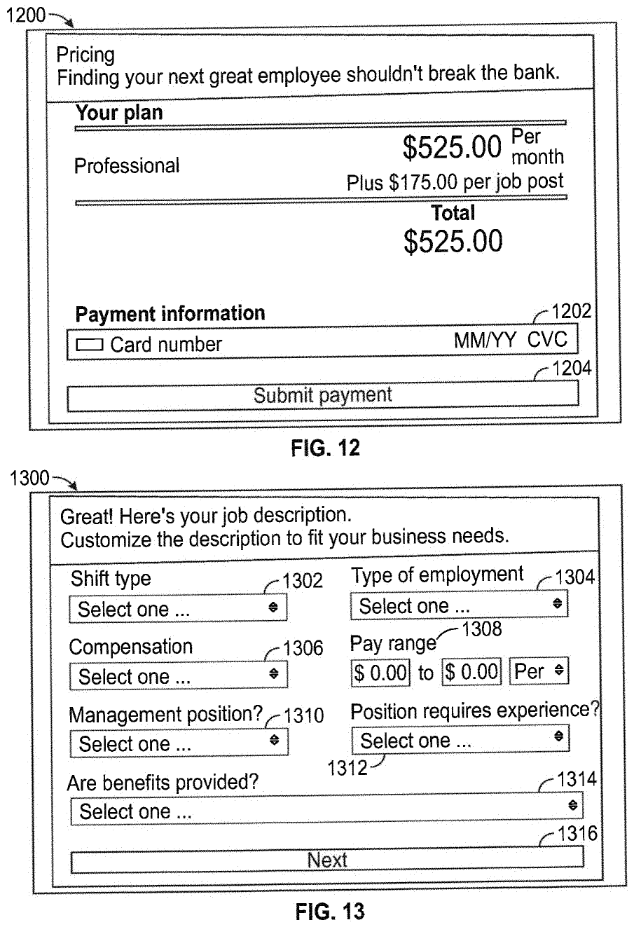

As described above, the various personality traits/dimensions may be identified using publicly or privately accessible information, such as information available from O*NET. Lastly, the overall match score 342 may be computed as a weighted average (based on ranking entered by the business user in FIG. 15) of the various metrics computed for skills and experience 302, cultural fit 304, management style 306, and personality dimensions 308. In other embodiments, many other ways of computing an overall match score 342 may be employed. For example, the score may include further categories in addition to or instead of categories 302, 304, 306, and 308. Further, as mentioned above, many other types of mathematical expressions, in addition to or instead of expressions 310, 320, 326, and 340 may be used to generate a quantitative evaluation of a candidate applicant's fitness for a particular job or for a class of jobs for which applicants are sought by a business owner. Example embodiment systems and methods are described below with reference to FIGS. 4 to 25.

FIG. 4 illustrates welcome screen 400 of a system interface, according to an embodiment of the present disclosure. In this example, screen 400 may be presented to a business user who accesses the system. Screen 400 may be provided on a GUI of a computing device such as a desktop computer, a laptop computer, a tablet computer, a smart phone, or other suitable computing device. Screen 400 may be generated by a software, hardware, or firmware application running locally on a computing device or may be an application that is running on a remote server that hosts the system.

A business user may invoke welcome screen 400 by starting the system in various ways. For example, the business user may select a hypertext link provided in a text message, email message, etc., or the business user may navigate to a known web address on a browser. Similarly, the system provides welcome screen 400 may be invoke in various other ways, such as by clicking an icon in a GUI, by invoking the system by issuing a command at a command-line prompt, etc. A business user may start a process to set up an account on the system and to enter or upload various pieces of relevant information by interacting with an interface, such as welcome screen 400. In this example, business user may select an icon 402 on the welcome screen to begin the process. Selecting icon 402 may cause the system to generate a new screen such as the screen shown in FIG. 5.

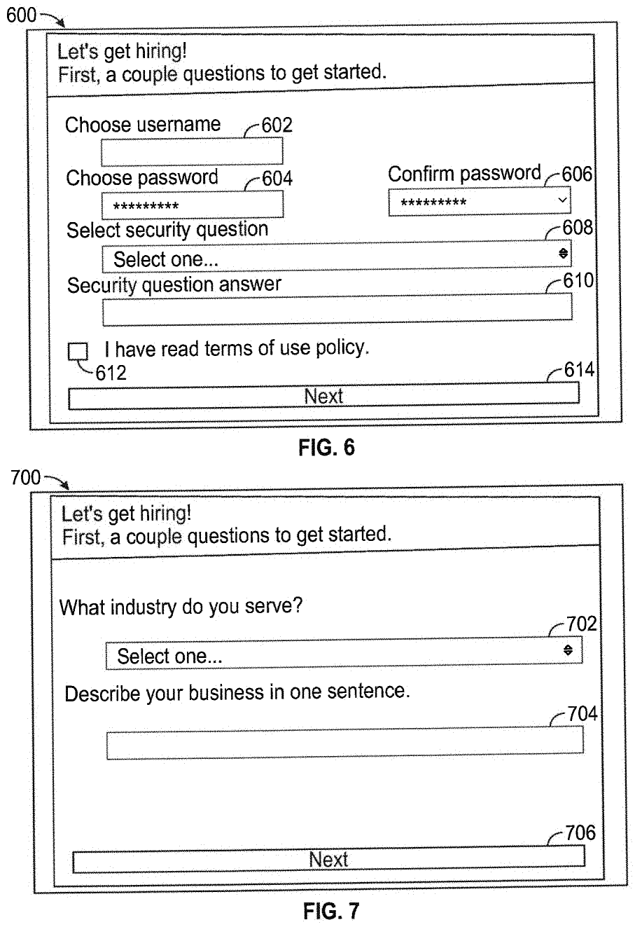

FIG. 5 illustrates contact information screen 500 of a system interface, according to an embodiment of the present disclosure. Screen 500 may instruct the business owner to supply various pieces of information. Screen 500 may be a form that accepts textual input or may allow the business user to upload information. In this example, a business owner may enter information including a first name 502, a last name 504, a business name 506, a business phone number 508, a primary hiring e-mail address 510, and a confirmation email address 512, in respective data entry boxes. In other embodiments, the contact information screen 500 may be formatted in any other suitable way that is convenient to the business owner that allows collection or relevant information. Once the business owner has supplied the requested information, they may confirm the information and move to the next step by selecting an icon 514 that causes the system to store the supplied information and to move to a new screen, as shown in FIG. 6 and described in greater detail below.

FIG. 6 illustrates an account creation screen 600 of a system interface, according to an embodiment of the present disclosure. In this example, screen 600 is provided to allow a business user to enter information relevant to creating a secure login account. In this regard, a business user may provide a user name 602 and may choose a password 604, by entering information in respective data entry boxes. The business user may then be prompted to confirm the selected password by providing the selected password once again in a corresponding password confirmation text entry box 606. Screen 600 may further include a selectable drop down menu 608 of standard selectable security questions. Once a security question is selected, a business user may provide an answer 610 to the security by providing the answer in the corresponding data entry box. On screen 600. the business user may be prompted to confirm that they have read and agree to a terms of use policy by selecting a visual selectable element 612 provided on screen 600. Once the business user has finished entering information required to create an account, the business user may select an icon 614 that causes the system to present a new screen, as shown in FIG. 7 and described in greater detail below.

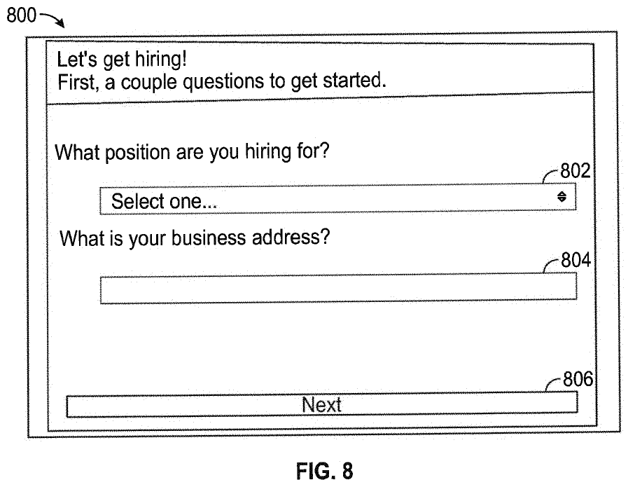

FIG. 7 illustrates a business description screen 700 of a system interface, according to an embodiment of the present disclosure. Screen 700 allows a business user to submit information related to the business that is hiring. This is a simplified example in which the business user is instructed to select a short industry description from a selectable pull-down menu 702. In this example, menu 702 allows the business user to select from a number of pre-determined descriptions of various industries that may apply to the business user. Further, in this example, the business user is requested to provide a short description of the business by entering text in a text entry box 704. The business user may submit the requested information and move to the next step of the process by selecting an icon 706 that causes the system to present a new screen, as shown in FIG. 8 and described in greater detail below.

FIG. 8 illustrates a position description screen 800 of a system interface, according to an embodiment of the present disclosure. Screen 800 allows a business user to enter information related to the position for which candidates are sought. In this simplified example, screen 800 allows a business user to select a description of the position from a selectable pull-down menu 802 of pre-determined position descriptions. A text entry box 804 is also provided to allow the business user to enter a business address. In further embodiments, screen 800 may have other instructions to the business user and respective text entry boxes and/or selectable menus to allow the business user to submit further information regarding the position. When the business user has finished entering the required information, they may select an icon 806 that causes the system to move to the next step of the process. In this example, the next step begins the process of collecting the business user's various preferences, as described in greater detail below.

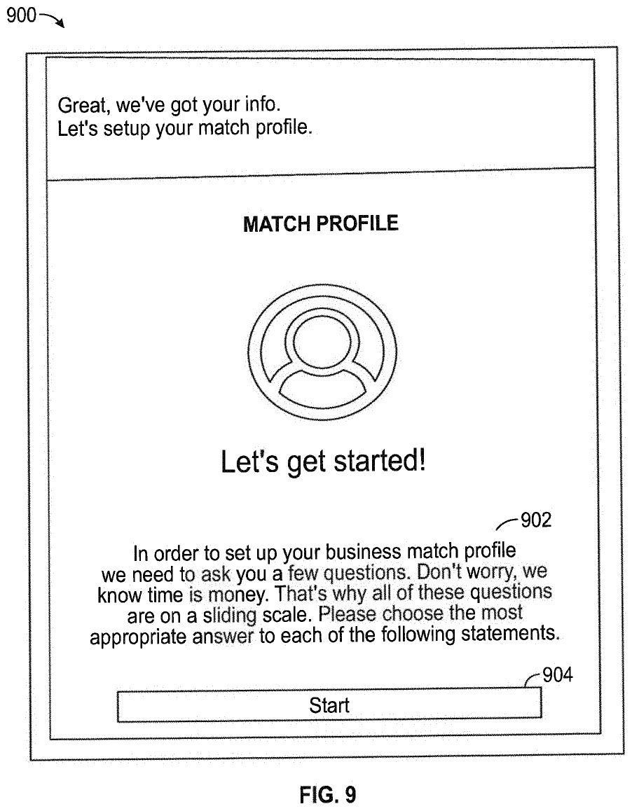

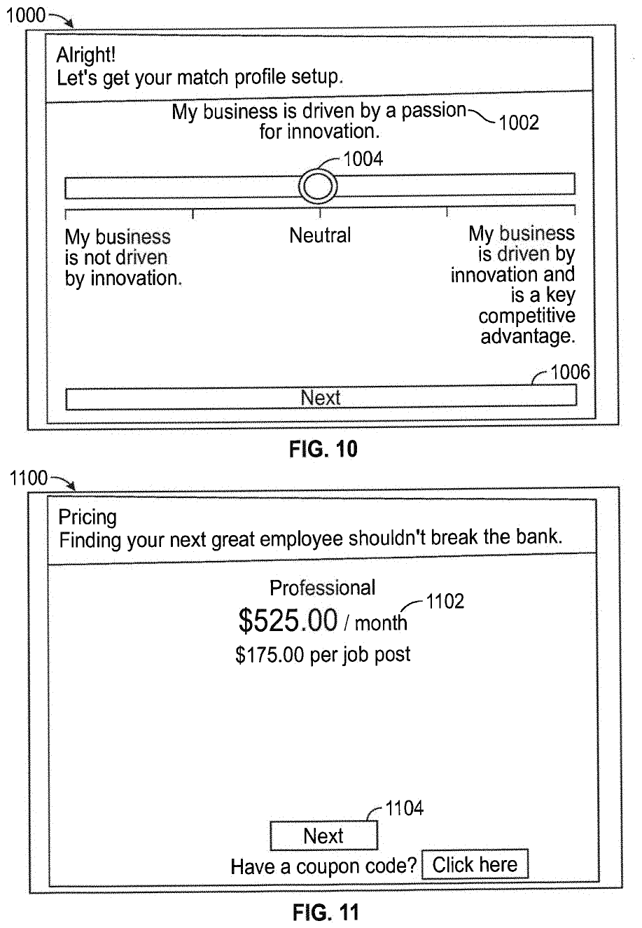

FIG. 9 illustrates a business assessment introductory screen 900 of a system interface, according to an embodiment of the present disclosure. Screen 900 is an example interface that begins the process of collecting the business user's preferences. As shown, screen 900 may provide some introductory information 902 that may inform the business user regarding what to expect and how to provide information requested in the business user assessment. When ready, the business user may initiate the process by selecting icon 904, which causes the system to present a new screen, as shown in FIG. 10 and described in greater detail below.

FIG. 10 illustrates a business assessment questionnaire screen 1000 of a system interface, according to an embodiment of the present disclosure. Screen 1000 illustrates one way in which responses to questions may be provided. In this example, a statement 1002 is provided that serves as the stimulus for the question. The business user is then given an opportunity to provide a response by indicating a degree to which he/she agrees with the statement. In this example, a selectable slider 1004 is provided. The business user can change the position of slider 1004 to indicate his/her response. As such, sliding to the left indicates that the business user agrees to a lesser extend with statement 1002 than when slider 1004 is moved to the right. Thus, by choosing a position of slider 1004, the business user is able to provide a numerical value for his/her answer that may be used in computing a score, as described above with reference to FIGS. 2 and 3.

In further embodiments, numerical data may be entered in other ways, such as by entering a number is a numerical input box (not shown). In further embodiments, data may be entered in any other way that is suitable, such as by uploading a list of responses to questions in the questionnaire. As with other screens, the business user may move to the next screen by selecting icon 1006. Selecting icon 1006 may cause the system to present the next question in a series of questions. Alternatively, when the assessment questionnaire is finished, the business user may move to the next step by selecting icon 1006.

FIG. 11 illustrates a pricing screen 1100 of a system interface, according to an embodiment of the present disclosure. Upon completion of the questionnaire described above with reference to FIG. 10, screen 1100 may allow the business user to enter information regarding a method of payment for the service. In this example, a price 1102 to be paid by the business user, for the service of creating the job posting and processing candidates, is shown. Other embodiments may include other pricing and/or licensing or subscription models. For example, a business that that uses the system on a regular basis may want to buy a subscription to the service or enter into a licensing arrangement. In this example, selecting an icon 1104 causes the system to present a new screen, as shown in FIG. 11 and described in greater detail below.

FIG, 12 illustrates a payment screen 1200 of a system interface, according to an embodiment of the present disclosure. Payment screen 1200 allows the business owner to enter information that provides a method of payment. For example, a credit card number, expiration date, etc., may be entered in a text entry box 1202. In further embodiments, screen 1200 may include further options for payment and may include additional selectable menus or text input boxes as needed to allow the business owner to enter the requested information. The payment may be submitted by selecting an icon 1204.

FIG. 13 illustrates a job posting information screen 1300 of a system interface, according to an embodiment of the present disclosure. Screen 1300 may allow the business user to enter specific information regarding the position that will be posted. Such information may include selectable menus to designate shift type 1302, type of employment 1304, compensation 1306, pay range 1308, whether the position is a management position 1310. Whether the position requires experience 1312, whether benefits are provided 1314, etc. When the business owner has finished entering the requested information, they may select icon 1316 to proceed to the next screed.

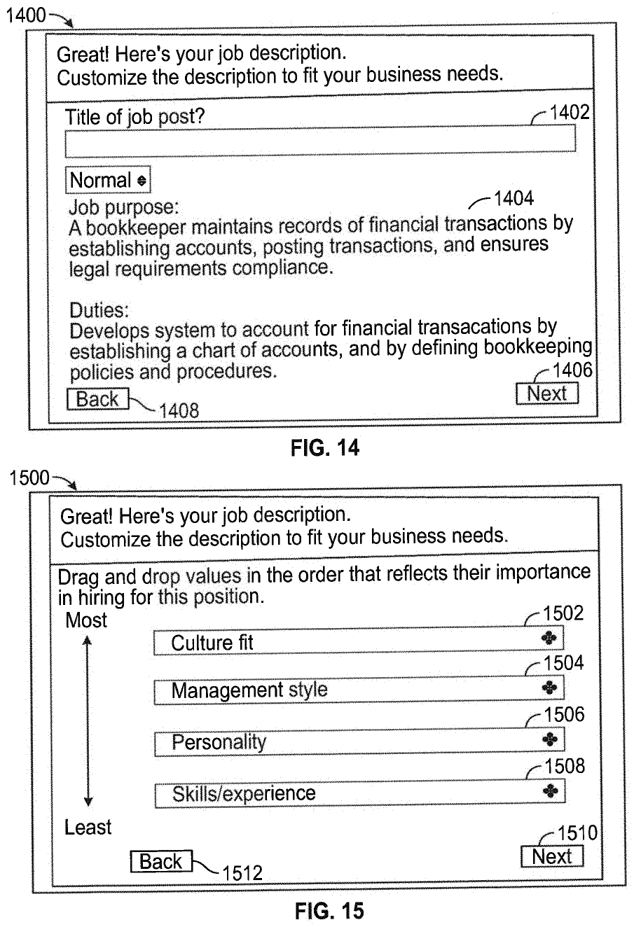

FIG. 14 illustrates a job description screen 1400 of a system interface, according to an embodiment of the present disclosure. Screen 1400 allows the business user to enter further information regarding to position. For example, a text entry box 1402 may allow the business user to enter a title for the job post. Further, an additional text box 1404 may allow that business user to type in a detailed description of the posted job. In other embodiments, other ways of entering the requested data may be provided including allowing the business user to upload a file containing the job description. Selecting a first icon 1406 may allow the business user to proceed to the next stage in the process. Alternatively, the business user may select a second icon 1408 to go back to a previous page to review and revise previously entered data if needed.

FIG. 15 illustrates a business preferences screen 1500 of a system interface, according to an embodiment of the present disclosure. In other embodiments, business user's preferences may be taken into consideration. Screen 1500 allows a business user to rank that various preferences that are important to the business user, such as culture fit 1502, management style 1504, personality 1506, and skill/experience 1508. Selecting a first icon 1510 may allow the business user to proceed to the next stage in the process. Alternatively, the business user may select a second icon 1512 to go back to a previous page to review and revise previously entered data if needed.

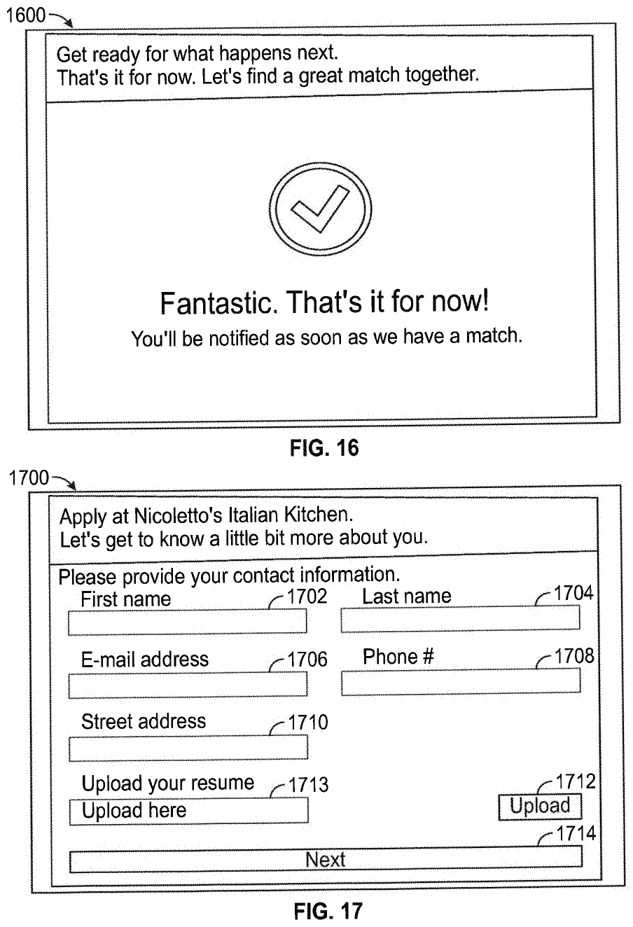

FIG. 16 illustrates a confirmation screen 1600 of a system interface, according to an embodiment of the present disclosure. Screen 160 may inform the business user that they have successfully completed the process of entering information to create an account and to generate a job posting. Screen 1600 may inform the business user that they may log out from the system and that they will be notified when one or more candidate matches have been determined.

FIG. 17 illustrates a candidate application screen 1700 of a system interface, according to an embodiment of the present disclosure. Screen 1700 may allow a candidate to begin the process of applying for a job posting that is posted on one or more electronic job boards that may be accessible over the internet or through other networks. Screen 1700 may allow the candidate to enter basic contact information such as a first name 1702, a last name 1704, an email address 1706, a phone number 1708, a physical address 1710, etc. The candidate may then be given an opportunity to provide a resume. For example, selecting icon 1712 may begin a process whereby the candidate may brows, select, and upload 1713 their resume that was previously created and stored in an electronic file. Selecting icon 1714 causes the system to move to the next screen.

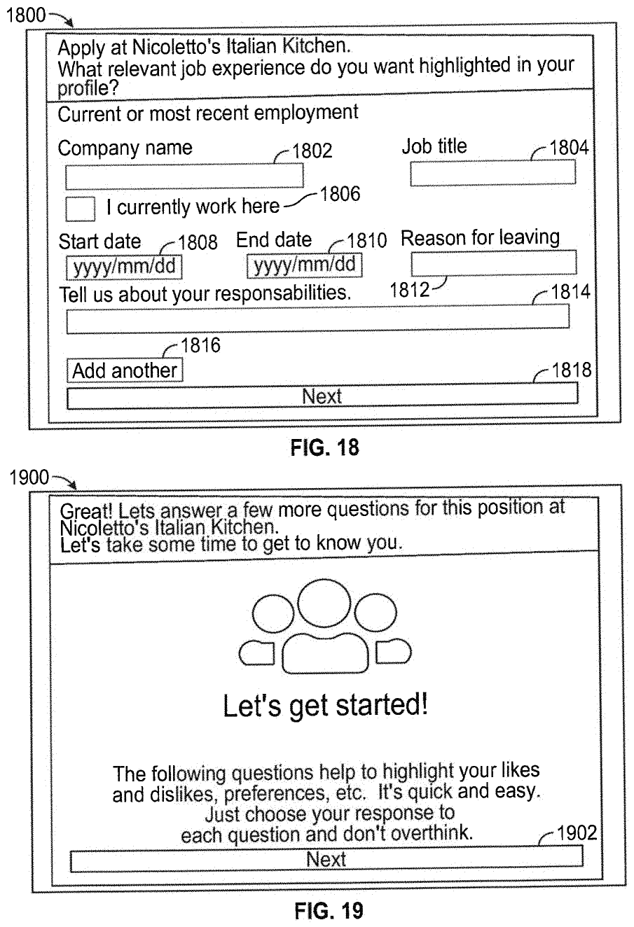

FIG. 18 illustrates an experience information screen 1800 of a system interface, according to an embodiment of the present disclosure. Screen 1800 may allow the candidate to enter information relating to their employment history. For example, the candidate may enter a company name 1802, a job title 1804, an indication regarding current employment 1806, a start date 1808, an end date 1810, a reason for leaving 1812, etc. The candidate may further be given an opportunity to describe their experience in detail by entering text in a text entry box 1814. Selecting a first icon 1816 gives the candidate an opportunity to enter further information regarding other positions that they have held. The candidate may select a second icon 1818 to move to the next screen.

FIG. 19 illustrates an assessment introductory screen 1900 of a system interface, according to an embodiment of the present disclosure. Screen 1900 may introduce the candidate the process of taking the assessment questionnaire. Selecting icon 1902 begins the process and causes the system to go to the next screen.

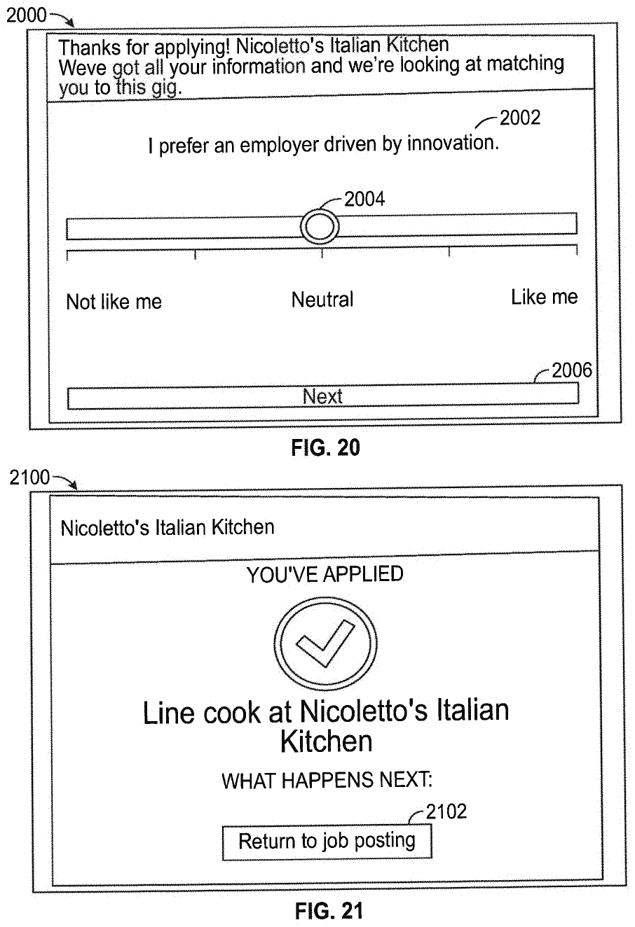

FIG. 20 illustrates a candidate assessment questionnaire screen 2000 of a system interface, according to an embodiment of the present disclosure. A question or statement 2002 may be provided as a stimulus for the candidate. As was the case with the business user questionnaire, described above, the candidate may interact with a slider 2004 to indicate their preference by moving the slider in a first direction or a second direction. For example, the stimulus 2002 may provide a statement such as “I prefer and employer that is driven by innovation.” Moving slider 2004 to the right indicates that the candidate agrees with the statement. Alternatively, moving slider 2004 to the left indicates that this issue is not that important to the candidate. Selecting icon 2006 causes the system to display the next page which may contain another question of the questionnaire or may be a confirmation page that the candidate has finished the assessment.

FIG. 21 illustrates a candidate confirmation screen 2100 of a system interface, according to an embodiment of the present disclosure. Screen 2100 informs that candidate that they have finished the process of applying for a posted position and lets them know what to expect regarding next steps in the hiring process. Selecting icon 2102 ends the process and either returns the candidate to a listing of posted jobs or provides the candidate an opportunity to log out of the system.

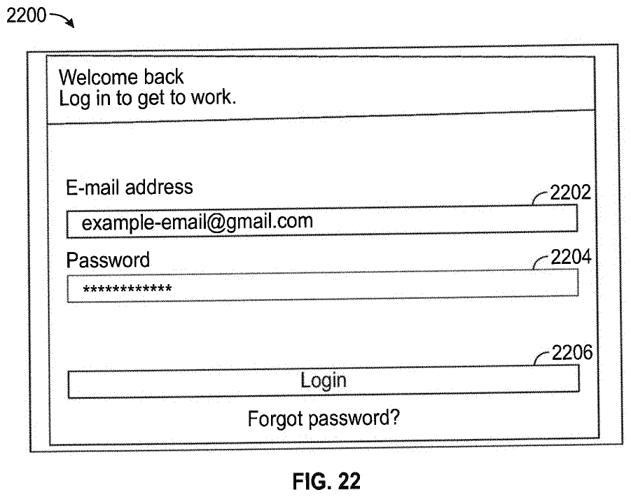

FIG. 22 illustrates a business login screen 2200 of a system interface, according to an embodiment of the present disclosure. Screen allows a business user to log into the system and review one or more matches that the system has found. A match may be determined when a candidate applicant's preferences and experience are determined to be suitable to a posted position as determined by the information entered by the business user and by the candidate, as described in greater detail above. In this example, login screen 2200 provides an opportunity for the business user to enter a login 2202 and password 2204 and begin the login process by selecting an icon 2206.

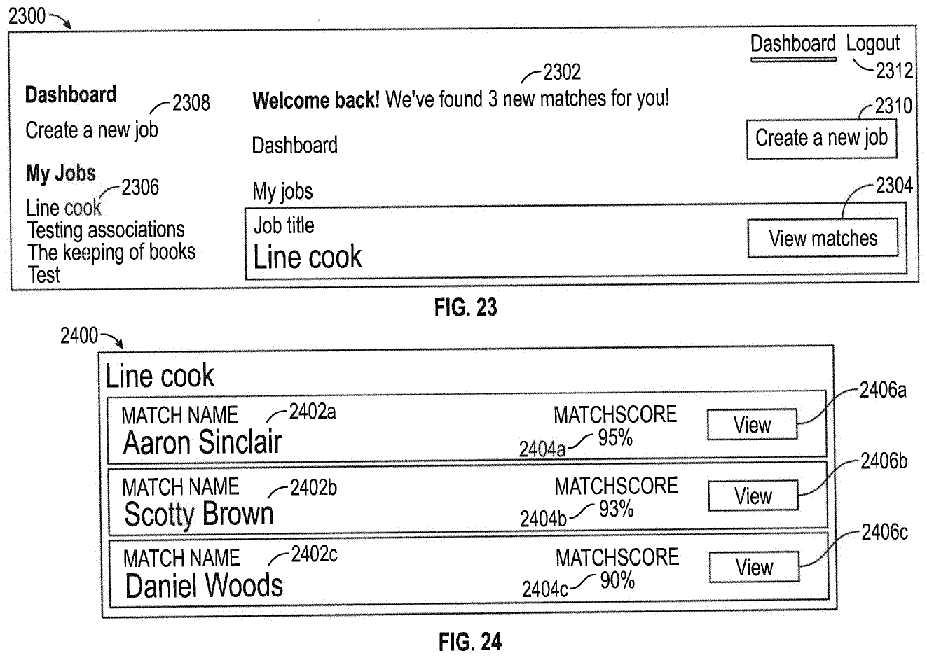

FIG. 23 illustrates a business dashboard 2300 of a system interface, according to an embodiment of the present disclosure. Dashboard 2300 may include an indication 2302 regarding matches and may allow the business user to view matches by selecting an icon 2304. Selecting icon 2304 causes the system to open a new screen 2400 showing a list of matches, as described in greater detail below with reference to FIG. 24. Dashboard 2300 may provide further functionality for the business user such as a list of jobs 2306 and one or more icons, 2308 and 2310, which a business user may select t© begin a process of creating a new job posting. Dashboard 2300 may further include an icon 2312 that the business user may select in order to log off from the system.

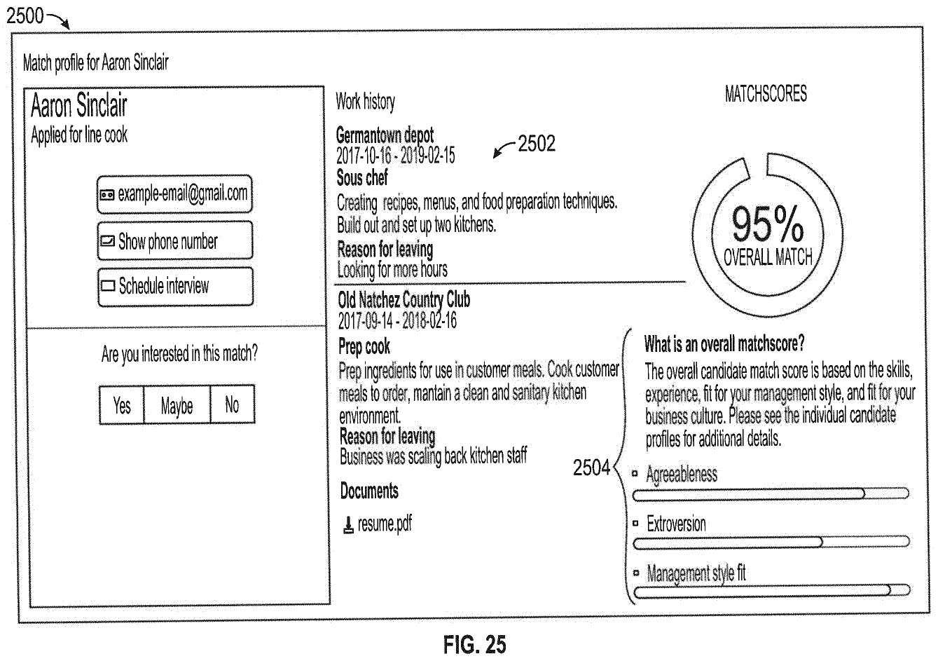

FIG. 24 illustrates a candidate match list screen 2400 of a system interface, according to an embodiment of the present disclosure. Screen 2400 may provide a list of matches including names of candidates (2402a, 2402b, 2402c, etc.) as well providing match scores (2404a, 2404b, 2404c, etc.). A business user may obtain further details regarding a give match by selecting an icon (2406a, 2406b, 2406c, etc.). Selecting an icon 2406a, 2406b, 2406, causes the system to open a new screen, as shown in FIG. 25, and described in greater detail below.

FIG. 25 illustrates a candidate summary screen 2500 of a system interface, according to an embodiment of the present disclosure. Screen 2500 may provide various details 2502 regarding the candidate applicant's skills and background as well as various details 2504 regarding the candidate applicant's preferences and personality traits. Based on the information provided in summary screen 2500 a business user may choose to select a candidate for an interview or other follow up steps in the hiring process. The business user may then choose to contact that candidate directly or may use the system to coordinate a process of reaching out to the candidate or follow up steps.

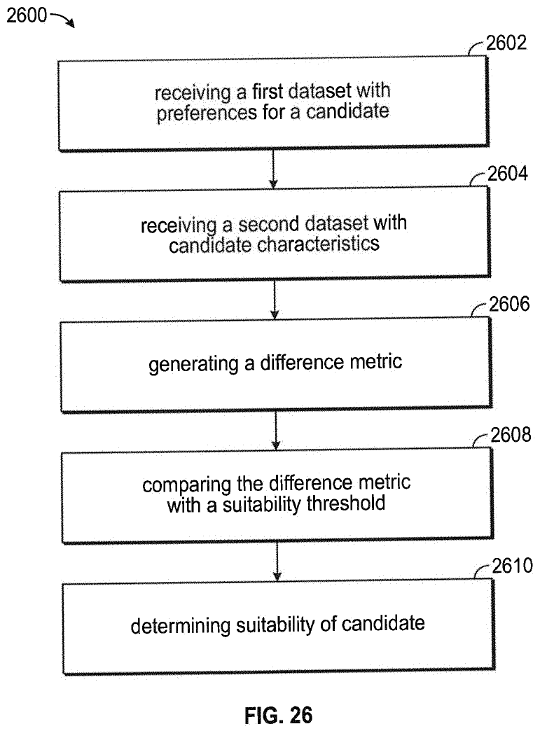

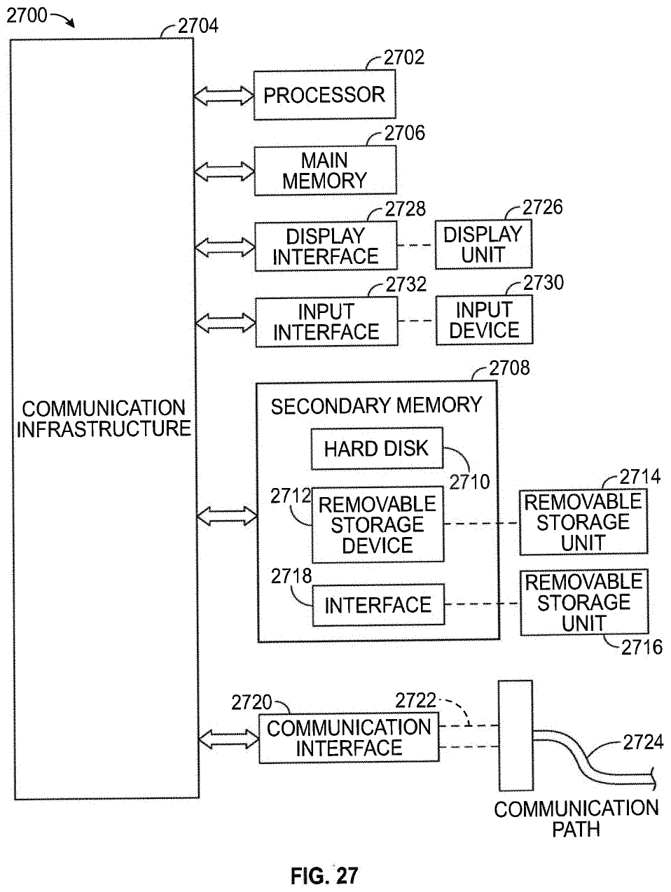

FIG. 26 is a flow chart 2600 illustrating a method of evaluating a candidate for employment, according to an embodiment of the present disclosure. In this example, the method may be a processor-implemented method that may be implemented using computer system elements as described in greater detail below with reference to FIG. 27.

In a first stage 2602, the method may include receiving a first dataset representing preferences for characteristics of an employee. In stage 2604, the method may include receiving a second dataset representing characteristics of the candidate for employment. Stage 2606 may include generating a difference metric that represents deviations between the first dataset and the second dataset, and stage 2608 may include comparing the difference metric to a predetermined suitability threshold. Lastly, in stage 2610, the method may include designating the candidate as a suitable candidate when the difference metric is less than the threshold.

As described in greater detail above, the first and second datasets may each include respective numerical values that represent preferences regarding one or more measures including: cultural fit, management style, personality traits, skills, and experience. Further, in stage 2602, generating the difference metric further include generating a score for each of the one or more measures, and generating the difference metric as a weighted sum of scores for each of the one or more measures. Further, generating the difference metric may further include generating a score that measures personality traits based on a personality model in which traits represented in the model are traits that are relevant to a particular business or industry. The difference metric may be generated as a vector difference between a first multi-dimensional vector and a second multi-dimensional vector, wherein numerical values in the first dataset are used as components of the first multi-dimensional vector, and wherein numerical values in the second dataset are used as components of the second multi-dimensional vector.

The processor-implemented method may further include controlling, by the processor, a display device and a user input device to perform various operations. The operations may include displaying, on the display device, questions to a user on a GUI, and receiving, by the user input device, user data from the user in response to the questions presented to the user on the GUI. The processor may be further configured to receive feedback regarding candidates that were previously identified as being suitable. The received feedback may then be used by the processor to further refine and customize the generation of the difference metric based on the received feedback.

Disclosed embodiments may be implemented in hardware, firmware, software, or any combination thereof Embodiments may also be implemented as instructions stored on a non-transitory machine-readable medium, which may be read and executed by one or more processor circuits (i.e., “processors”). A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical optical, acoustical or other forms of propagated signals (e.g., carrier waves, infrared signals, digital signals, etc.), and others. Firmware, software routines, and computer program instructions may be described herein as performing certain actions or operations. However, such descriptions are merely for convenience of description. Such actions or operations, in fact, result from computing devices, processors, controllers, or other devices executing the firmware, software, routines, instructions, etc.

FIG. 27 is a block diagram of an example computer system 2700 in which disclosed embodiments of, or portions thereof, may be implemented as computer-readable code (i.e., machine-readable computer program instructions), which is executed by one or more processors causing the one or more processors to perform operations of the disclosed embodiments, according to an embodiment.

Disclosed systems may include components implemented on computer system 2700 using hardware, software, firmware, tangible computer-readable (i.e., machine-readable) media having computer program instructions stored thereon, or a combination thereof, and may be implemented in one or more computer systems or other processing system.

If programmable logic is used, such logic may be executed on a commercially available processing platform or a on a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various disclosed embodiments are described in terms of this example computer system 2700. After reading this description, persons of ordinary skill in the relevant art will know how to implement disclosed embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As persons of ordinary skill in the relevant art will understand, a computing device for implementing disclosed embodiments has at least one processor, such as processor 2702, wherein the processor may be a single processor, a plurality of processors, a processor in a multi-core/multiprocessor system, such system operating alone, or in a cluster of computing devices operating in a cluster or server farm. Processor 2702 may be connected to a communication infrastructure 2704, for example, a bus, message queue, network, or multi-core message-passing scheme.

Computer system 2700 may also include a main memory 2706, for example, random access memory (RAM), and may also include a secondary memory 2708. Secondary memory 2708 may include, for example, a hard disk drive 2710, removable storage drive 2712. Removable storage drive 2712 may include a floppy disk drive, a magnetic tape drive, an optical disk drive, a flash memory, or the like. The removable storage drive 2712 may be configured to read and/or write data to a removable storage unit 2714 in a well-known manner. Removable storage unit 2714 may include a floppy disk, magnetic tape, optical disk, etc., which is read by and written to, by removable storage drive 2712. As will be appreciated by persons of ordinary skill in the relevant art, removable storage unit 2714 may include a computer readable storage medium having computer software (i.e., computer program instructions) and/or data stored thereon.

In alternative implementations, secondary memory 2708 may include other similar devices for allowing computer programs or other instructions to be loaded into computer system 2700. Such devices may include, for example, a removable storage unit 2716 and an interface 2718. Examples of such devices may include a program cartridge and cartridge interface (such as that found in video game devices), a removable memory chip (such as EPROM or PROM) and associated socket, and other removable storage units 2716 and interfaces 2718 which allow software and data to be transferred from the removable storage unit 2716 to computer system 2700.

Computer system 2700 may also include a communications interface 2720. Communications interface 2720 allows software and data to be transferred between computer system 2700 and external devices. Communications interfaces 2720 may include a modem, a network interface (such as an Ethernet card), a communications port, a PCMCIA slot and card, or the like. Software and data transferred via communications interface 2720 may be in the form of signals 2722, which may be electronic, electromagnetic, optical, or other signals capable of being received by communications interface 2720. These signals may be provided to communications interface 2720 via a communications path 2724.

In this document, the terms “computer program storage medium” and “computer usable storage medium” are used to generally refer to storage media such as removable storage unit 2714, removable storage unit 2716, and a hard disk installed in hard disk drive 2710. Computer program storage medium and computer usable storage medium may also refer to memories, such as main memory 2706 and secondary memory 2708, which may be semiconductor memories (e.g., DRAMS, etc.). Computer system 2700 may further include a display unit 2726 that interacts with communication infrastructure 2704 via a display interface 2728. Computer system 2700 may further include a user input device 2730 that interacts with communication infrastructure 2704 via an input interface 2732. A user input device 2730 may include a mouse, trackball, touch screen, or the like.

Computer programs (also called computer control logic or computer program instructions) are stored in main memory 2706 and/or secondary memory 2708. Computer programs may also be received via communications interface 2720. Such computer programs, when executed, enable computer system 2700 to implement embodiments as discussed herein. In particular, the computer programs, when executed, enable processor 2702 to implement the processes of disclosed embodiments, such various stages in disclosed methods, as described in greater detail above. Accordingly, such computer programs represent controllers of the computer system 2700. When an embodiment is implemented using software, the software may be stored in a computer program product and loaded into computer system 2700 using removable storage drive 2712, interface 2718, and hard disk drive 2710, or communications interface 2720. A computer program product may include any suitable non-transitory machine-readable e., computer-readable) storage device having computer program instructions stored thereon.

Embodiments may be implemented using software, hardware, and/or operating system implementations other than those described herein. Any software, hardware, and operating system implementations suitable for performing the functions described herein may be utilized. Embodiments are applicable to both a client and to a server or a combination of both.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

What is claimed is:

1. A processor-implemented method of evaluating a candidate for employment, the method comprising:
receiving, by a processor circuit, a first dataset representing preferences for characteristics of an employee;
receiving a second dataset representing characteristics of the candidate for employment;
generating a difference metric that represents deviations between the first dataset and the second dataset;
comparing the difference metric to a predetermined suitability threshold; and
designating the candidate as a suitable candidate when the difference metric is less than the threshold.

2. The method of claim 1, wherein the first and second datasets each include respective numerical values that represent preferences regarding one or more measures including: cultural fit, management style, personality traits, skills, and experience.

3. The method of claim 2, wherein generating the difference metric further comprises:
generating a score for each of the one or more measures; and
generating the difference metric as a weighted sum of scores for each of the one or more measures.

4. The method of claim 2, wherein generating the difference metric further comprises:
generating a score that measures personality traits based on a personality model in which traits represented in the model are traits that are relevant to a particular business or industry.

5. The method of claim 1, further comprising:
generating the difference metric as a vector difference between a first multi-dimensional vector and a second multi-dimensional vector,
wherein numerical values in the first dataset are used as components of the first multi-dimensional vector, and
wherein numerical values in the second dataset are used as components of the second multi-dimensional vector.

6. The method of claim 1, wherein receiving the first dataset and receiving the second dataset further comprises:
controlling, by the processor, a display device and a user input device to perform operations including:
displaying, on the display device, questions to a user on a graphical user interface (GUI); and
receiving, by the user input device, user data from the user in response to the questions presented to the user on the GUI.

7. The method of claim 6, further comprising:
receiving feedback regarding candidates identified as suitable; and
refining and customizing the generation of the difference metric based on the received feedback.

8. A system configured to evaluate a candidate for employment, the system comprising:
a processor circuit configured to perform operations including:
receiving a first dataset representing preferences for characteristics of an employee;
receiving a second dataset representing characteristics of the candidate for employment;
generating a difference metric that represents deviations between the first dataset and the second dataset;
comparing the difference metric to a predetermined suitability threshold; and
designating the candidate as a suitable candidate when the difference metric is less than the threshold.

9. The system of claim 8, wherein the processor circuit is further configured to generate the difference metric based on the first and second datasets, the first and second datasets each including respective numerical values that represent preferences regarding one or more measures including:
cultural fit, management style, personality traits, skills, and experience.

10. The system of claim 9, wherein the processor circuit is further configured to generate the difference metric by performing operations comprising:
generating a score for each of the one or more measures; and
generating the difference metric as a weighted sum of scores for each of the one or more measures.

11. The system of claim 9, wherein the processor circuit is further configured to generate the difference metric by performing operations comprising:
generating a score that measures personality traits based on a personality model in which traits represented in the model are traits that are relevant to a particular business or industry.

12. The system of claim 8, wherein the processor circuit is further configured to perform operations comprising:
generating the difference metric as a vector difference between a first multi-dimensional vector and a second multi-dimensional vector,
wherein numerical values in the first dataset are used as components of the first multi-dimensional vector, and
wherein numerical values in the second dataset are used as components of the second multi-dimensional vector.

13. The system of claim 8, further comprising:
a display device; and
a user input device,
wherein the processor circuit is further configured to receive the first dataset and to receive the second dataset by performing operations comprising:
controlling the display device and the user input device to perform operations including:
displaying, on the display device, questions to a user on a GUI; and
receiving, by the user input device, user data from the user in response to the questions presented to the user on the GUI.

14. The system of claim 13, wherein the processor circuit is further configured to perform operations comprising:
receiving feedback regarding candidates identified as suitable; and
refining and customizing the generation of the difference metric based on the received feedback.

15. A non-transitory machine-readable storage medium having computer program instructions stored thereon that, when executed by a processor circuit, cause the processor circuit to perform operations comprising:
receiving a first dataset representing preferences for characteristics of an employee;
receiving a second dataset representing characteristics of the candidate for employment;
generating a difference metric that represents deviations between the first dataset and the second dataset;
comparing the difference metric to a predetermined suitability threshold; and
designating the candidate as a suitable candidate when the difference metric is less than the threshold.

16. The non-transitory machine-readable storage medium of claim 15, wherein the first and second datasets each include respective numerical values that represent preferences regarding one or more measures including: cultural fit, management style, personality traits, skills, and experience.

17. The non-transitory machine-readable storage medium of claim 16, further comprising computer program instructions stored thereon that, when executed by the processor circuit, cause the processor circuit to perform operations comprising:
generating a score for each of the one or more measures; and
generating the difference metric as a weighted sum of scores for each of the one or more measures.

18. The non-transitory machine-readable storage medium of claim 16, further comprising computer program instructions stored thereon that, when executed by the processor circuit, cause the processor circuit to generate the difference metric by performing operations comprising:
generating a score that measures personality traits based on a personality model in which traits represented in the model are traits that are relevant to a particular business or industry.

19. The non-transitory machine-readable storage medium of claim 15, further comprising computer program instructions stored thereon that, when executed by the processor circuit, cause the processor circuit to perform operations comprising:
generating the difference metric as a vector difference between a first multi-dimensional vector and a second multi-dimensional vector,
wherein numerical values in the first dataset are used as components of the first multi-dimensional vector, and
wherein numerical values in the second dataset are used as components of the second multi-dimensional vector.

20. The non-transitory machine-readable storage medium of claim 15, further comprising computer program instructions stored thereon that, when executed by the processor circuit, cause the processor circuit to receive the first dataset and receive the second dataset by performing operations comprising:
controlling a display device and a user input device to perform operations including:
displaying, on the display device, questions to a user on a GUI; and
receiving, by the user input device, user data from the user in response to the questions presented to the user on the GUI.
